(19) United States
(12) Patent Application Publication
(10) Pub. No.: US 2010/0077007 A1
(43) Pub. Date: Mar. 25, 2010

(54) Method and System for Populating a Database With Bibliographic Data From Multiple Sources

(76) Inventors: Jason White, Ottawa (CA); Asad Abbasi, Kanata (CA)

Correspondence Address: EDELL, SHAPIRO & FINNAN, LLC, 1901 RESEARCH BLVD., SUITE 400, ROCKVILLE, MD, 20850-3164, US

(21) Appl. No.: 12/562,217

(22) Filed: Sep. 18, 2009

Related U.S. Application Data
(60) Provisional application No. 61/136,602, filed on Sep. 18, 2008.
(60) Provisional application No. 61/193,656, filed on Dec. 12, 2008.

(51) Int. Cl. G06F 17/30; G06F 7/00

(52) U.S. Cl. 707/791; 707/803; 707/E17.046; 707/705

(57) ABSTRACT

There is disclosed a method of populating a relational database of bibliographic data associated with one or more document-based collections, wherein the bibliographic data is sourced from two or more sources having distinct source-specific formats. The method generally comprises the steps of accessing source data from the two or more sources; independently standardizing the accessed data from each of the two or more sources in accordance with a common intermediate source-independent format dictated by an intermediate data structure, such that similar data elements from distinct source-specific formats are commonly identified within the intermediate format; and further interpreting the standardized data in relation to stored database elements comprising at least some database elements derived from each of the two or more sources, for populating the database in accordance with the relation with at least some repetitive elements replaced with reference thereto, consistent with a refined database data structure distinct from the intermediate data structure. A system and computer-readable medium for implementing the above method are also disclosed.

### CROSS-REFERENCE TO RELATED APPLICATIONS

This application claims priority under 35 U.S.C. §119(e) on U.S. Provisional Application No. 61/136,602 filed on Sep. 18, 2008, and U.S. Provisional Application No. 61/193,656 filed on Dec. 12, 2008. The entire disclosures of these applications are incorporated herein by reference.

### FIELD OF THE INVENTION

The invention relates to database management systems, and more particularly to a method and system for populating a database with bibliographic data from multiple sources.

### BACKGROUND

There are many ways in which a database may be populated with relational data, depending on the context in which it is used. The data may be entered one piece at a time through a user interface, or gathered from some other data source in an automatic fashion. In many systems, a database is populated from several data sources, interpreting each source in its own fashion, and then associating and adding the data to the other data already existing in the database. For example, source data files in a source-specific format can be acquired and transformed directly into a proper format for a database, for example, based on a pre-defined source-to-database transformation. Namely, if a source-specific format or schema (i.e., source data structure) is known, an appropriate transformation may be developed to interpret acquired source data for directly populating a database in accordance with a pre-defined database format or schema (i.e., destination data structure).

When populating a database from a single data source comprising data files in the same format, the process can be relatively straightforward. However, one challenge occurs when populating a database from different sources which provide data in different formats (i.e., distinct source schemas). One solution to this challenge is to take the raw data from the source and interpret this data to obtain the data in a format suitable for populating the database on a per source basis. With this technique, a separate interpreter is required to populate the database with files from each source; namely, a series of source-specific interpreters configured to interpret source data formatted in accordance with a source-specific schema, for direct transformation and import to the database in accordance with a destination schema. In addition to requiring separate interpreters or a separate interpretation protocol for each source, this approach may also be limited in terms of establishing links that exist between files coming from the different sources and hence being passed through different interpreters. This problem can be exacerbated when a database is being populated with complex interrelated data from a plurality of sources.

In general, known multi-source database population methods are limited in their implementation of source-specific interpretation for direct relational database population. Namely, most solutions involve the direct source-specific transformation of source data in a source-specific format (i.e., dictated by a source-specific data structure or schema) for direct population of the database in accordance with a final database data structure. For example, in “Olfactory Receptor Database: a metadata-driven automated population from sources of gene and protein sequences,” 354-360, Nucleic Acids Research, 2002, Vol. 30, No. 1, data is downloaded from different sources in different source-specific formats. The downloaded HTML files are first parsed to extract information relevant to the database. If, for example, the HTML parsing program identifies that the olfactory receptor sequence was cloned for the organism Mus musculus, it matches the string mus musculus against the knowledge base for the database. The program can determine that mus musculus corresponds to the organism attribute a30 and is stored in the database as object o144. An XML-encoded document is created, with the XML line <a30 object_name=‘mus musculus’>o144</a30>. This XML-encoded file contains the data extracted in a format compliant with the structured database architecture for importing into the database. With this complicated approach, files from each different source must be interpreted in a source-specific manner for populating the database directly based on relations or matches to elements within the database knowledge base. Systems such as this one that attempt to directly interpret data in different formats accessed from different sources by finding matches or relations to elements within the same source file can be very inefficient. Other examples sharing this approach can be found in the following references: “Data Warehouse Population Platform,” Proceeding of the 5th International Workshop on the Design and Management of Data Warehouses, 2003; and “Biozon: a System for Unification, Management and Analysis of Heterogeneous Biological Data,” published online by BMC Bioinformatics, 2006. In the latter reference, which provides a complex approach to source-specific data transformations for direct database population that enables the identification of intricate interrelations between data from distinct sources, given the general shortcomings of direct database population transformations from diverse source-specific schemas to the destination database schema, post database population cleaning/filtering is implemented, for example, to reduce duplicates and inconsistencies in the populated data.

Alternative solutions propose first defining interrelations between distinct source schemas or data structures, and leveraging these interrelations in assessing or integrating multiple source data. U.S. Patent Application Publication No. 2008/0183658 provides such an example, wherein object relationships are established between sources in populating a multiple source relationship table for further assessment (i.e., reporting). In “Source Integration in Data Warehousing,” DWQ Foundations of Data Warehouse Quality, Proceedings of the 9^{th}, International Workshop on Database and Expert Systems Applications (DEXA-98), pages 192-197, IEEE Computer Society Press, 1998, a conceptual representation of each data source is built to enable understanding and representation of relationships between these data sources (i.e., intermodel assertions), which are then used for data integration. While this may lead to a greater integration of data from distinct sources, significant effort is required not only to recognize different source structures or schemas, but also to adequately understand and represent how different source schemas can be interrelated to populate the database, based on a pre-defined destination schema using these inter-source representations, which, inherently, must be revised each time a source schema is changed or modified, or expanded upon accessing a new source. Another example published as “Using AutoMed Metadata in Data Warehousing Environments,” Proceedings of the 6th ACM International Workshop on Data Warehousing and OLAP, 2003, consists of incrementally integrating each source-specific schema into a destination schema by incrementally transforming source schemas using a sequence of primitive transformations, each one of which is stored along with the transformation pathway defined thereby to provide access to a complete representation of the data conversion process. Included in these incremental transformations are multi-source cleaning operations that leverage pre-defined source-dependent data interrelations in populating incrementally combined data representations. While this incremental procedure provides some advantages in the wealth of transformation information rendered available (i.e., recorded pathways), including details with respect to inter-source merging operations, its complexity may not be particularly suitable for some applications where the benefits of recorded pathways may be outweighed by a simplified process with reduced computational and storage requirements.

For databases dealing with documents, the relevant data (i.e., bibliographic data) to populate the database can include the document itself and/or document-related data, such as metadata. Such metadata can be simple, such as a document identifying number, or complex with various data items that may be interrelated and/or linked to other data or documents. The general approach to managing multiple source data in a document-based or document-related database or data warehouse is similar to that described above, wherein while data from distinct sources may be combined within and accessed from a same database structure of schema, interrelations between such distinct source data are often neglected or omitted due to the direct transformation and import of such data into a centralized repository. While some solutions are discussed above for some level of multisource integration, oftentimes at the expense of a significant increase in complexity along with other potential shortcomings, such solutions have not been readily applied to document-based systems. Alternatively, different measures have been devised to implement comprehensive searches and analyses of distinct source systems, rather than to effectively combine data from such sources. Examples of this approach are provided in European Patent Application Publication No. 1 182 578, United States Patent Application Publication No. 2008/0086450, United States Patent Application Publication No. 2003/0220897 and United States Patent Application Publication No. 2002/0022974. While these approaches may lead to more comprehensive search strategies through multiple source data, they do not address the challenges in integrating such multiple source data in a combined database or warehouse.

Therefore, there is a need for a database population method and system that overcomes at least some of the disadvantages of previous methods and systems, or at least provides the public with a useful alternative. Namely, there is a need for a new and useful method for populating a database with bibliographic data from multiple sources.

This background information is provided to reveal information believed by the applicant to be of possible relevance to the invention. No admission is necessarily intended, nor should be construed, that any of the preceding information constitutes prior art against the invention.

### SUMMARY OF THE INVENTION

An object of the invention is to provide a database population method, system and computer-readable medium therefor.

A further object of the invention is to provide a method, system and computer-readable medium for populating a database with bibliographic data from multiple sources.

In accordance with one aspect of the invention, there is provided a method of populating a relational database of bibliographic data associated with one or more document-based collections, wherein said bibliographic data is sourced from two or more sources having distinct source-specific formats, comprising the steps of: accessing source data from the two or more sources; independently standardizing said accessed data from each of the two or more sources in accordance with a common intermediate source-independent format dictated by an intermediate data structure, such that similar data elements from distinct source-specific formats are commonly identified within said intermediate format; and further interpreting said standardized data in relation to stored database elements comprising at least some database elements derived from each of the two or more sources, for populating the database in accordance with said relation with at least some repetitive elements replaced with reference thereto, consistent with a refined database data structure distinct from said intermediate data structure.

In accordance with another aspect of the invention, there is provided a system for populating a relational database of bibliographic data associated with one or more document-based collections, wherein said bibliographic data is sourced from two or more sources having distinct source-specific formats, the system comprising: one or more data storage devices configured to define an intermediate data structure and a refined database data structure distinct therefrom, and for storing database elements derived from each of the two or more sources in accordance with said refined database data structure; independent standardization modules for independently standardizing data accessed from the two or more sources in accordance with a common intermediate source-independent format dictated by said intermediate data structure, such that similar data elements from distinct source-specific formats are commonly identified within said intermediate format; and an interpreter for further interpreting said standardized data in relation to said stored database elements from each of the two or more sources for populating the database in accordance with said relation with at least some repetitive elements replaced with reference thereto, consistent with said refined database data structure.

In accordance with another aspect of the invention, there is provided a computer-readable medium for populating a relational database of bibliographic data associated with one or more document-based collections accessed from two or more sources in distinct source-specific formats, comprising statements and instructions for implementation by a computing device to implement the steps of: independently standardizing said accessed data from each of the two or more sources in accordance with a common intermediate source-independent format dictated by an intermediate data structure, such that similar data elements from distinct source-specific formats are commonly identified within said intermediate format; and further interpreting said standardized data in relation to stored database elements comprising at least some database elements derived from each of the two or more sources, for populating the database in accordance with said relation with at least some repetitive elements replaced with reference thereto, consistent with a refined database data structure distinct from said intermediate data structure.

Other aims, objects, advantages and features of the invention will become more apparent upon reading of the following non-restrictive description of specific embodiments thereof, given by way of example only with reference to the accompanying drawings.

### BRIEF DESCRIPTION OF THE DRAWINGS

The invention will be described with reference to the accompanying drawings, wherein:

FIG. 1 is a schematic representation of a known system for populating a database with data from different sources;

FIG. 2 is a schematic representation of a system for populating a database with data from different sources having distinct source-specific formats, according to an embodiment of the invention;

FIG. 3 is a schematic representation of a system for populating a database with data from different sources having distinct source-specific formats, according to another embodiment of the invention;

FIG. 4 is an example of a portion of a common intermediate data structure applicable in the context of a relational patent database according to an embodiment of the invention; and

FIG. 5 is an example of a portion of a refined database data structure of a relational patent database according to an embodiment of the invention.

### DETAILED DESCRIPTION OF THE PREFERRED EMBODIMENTS

Unless defined otherwise, all technical and scientific terms used herein have the same meaning as commonly understood by one of ordinary skill in the art to which this invention belongs.

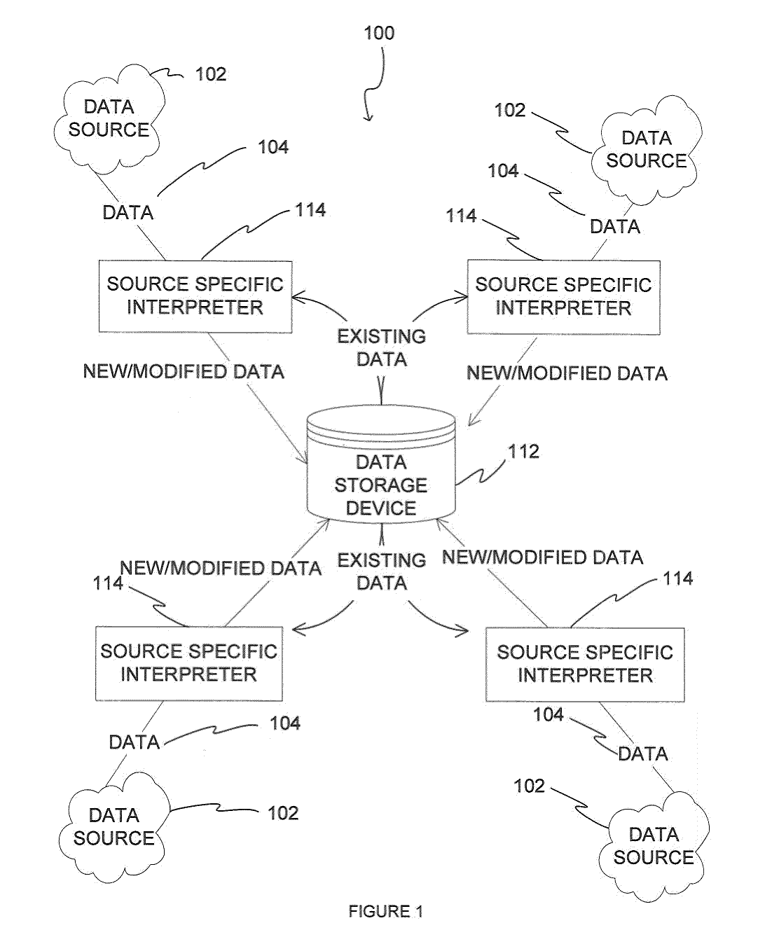

A schematic representation of a known system 100 for populating a database with data from different data sources is provided in FIG. 1. In this example, there are four different data sources 102, which generally provide data in different source-specific formats. A source specific interpreter 114 is used to interpret the accessed data 104 from each source for populating the database in reference to the database's existing data. The stored database elements (e.g., existing data) can be stored in the data storage device 112. Systems such as this one that attempt to directly normalize or interpret data in different formats accessed from different sources by finding matches or relations to elements within the database (e.g., existing data) or within the same source file may be very inefficient. Furthermore, this system can be limited in the links that can be formed between data provided from different sources and interpreted via different interpreters. In some systems which interpret and populate directly from files in different source-specific formats, data derived from different sources are essentially in separate tables within the main database, as links exist only between data derived from the same source. Further, if the structure of the database is changed, all interpretive programs must be altered to accommodate the new structure.

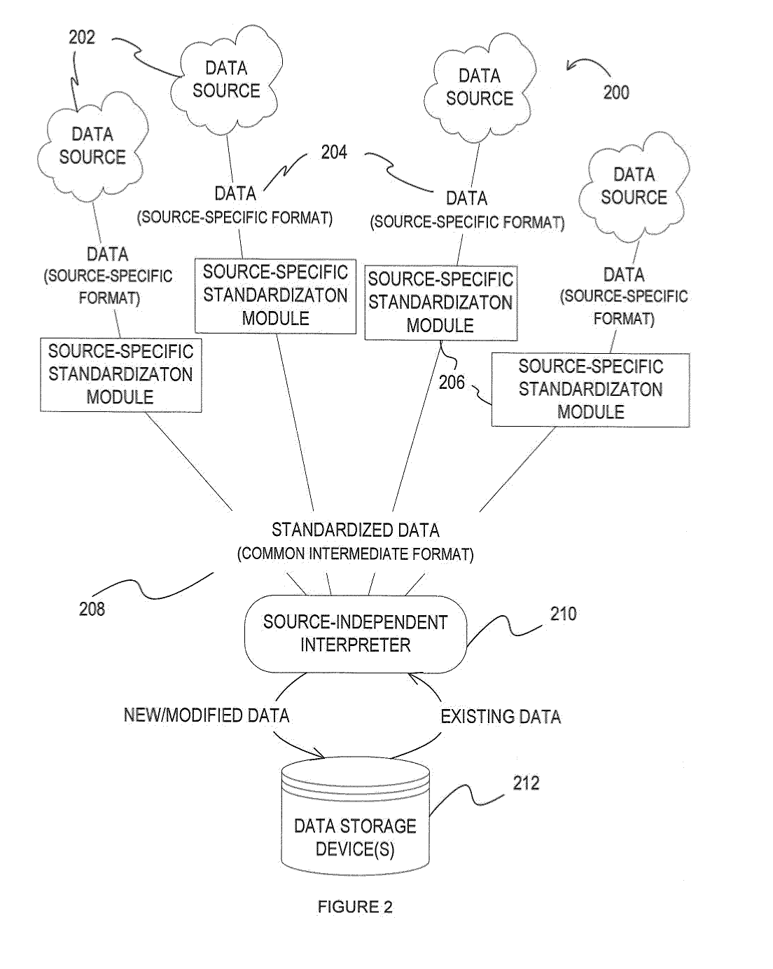

Referring now to FIG. 2, and in accordance with one embodiment of the invention, a schematic representation of a system 200 for populating a database with bibliographic data from different data sources having distinct source-specific formats is presented, wherein said bibliographic data is generally associated with one or more document-based collections. Examples of document-based collections may include, but are not limited to, documents published or otherwise made available by different publishers, editors, retail outlets, libraries, etc. and/or different specialized document management systems (e.g., scientific/academic documents such as publications, journal articles, books, course materials, etc.; legal documents such as case law, patents and patent applications, citations, case histories, etc.; literary works such as books, novels, magazines, etc.). It will be appreciated that different collections may be accessed from distinct resources (i.e., different data service providers, publishers, data repositories, etc.) as can different collections be accessed from a same combined resource (e.g., distinct journals from a same publisher, distinct national patent resources from a same regional or international patent library, distinct collections managed by a same data access service provider, etc.). These and other such considerations should become apparent to the person of ordinary skill in the art and are therefore not intended to depart from the general scope and nature of the present disclosure. Furthermore, it will be appreciated that bibliographic data may include, but is not limited to, different data associated or to be associated with a particular document, or group thereof, in representing not only its origin and format, such as author(s), publisher(s), publication date(s), original and/or translated languages, publication type, number of pages, but also information associated or identified as relevant to this document, such as citations, forward and/or backward references, reviews, processing history (e.g., prosecution history for patent-related documents), different versions or revisions, associated publications (e.g., different documents from a same document family), and the like. In some embodiments, bibliographic data applies equally to the document itself, and/or portions thereof, as to the information relating to or associated with this document. These and other such considerations will be apparent to the person of ordinary skill in the art, depending on the context in which and the application for which the embodiments of the invention are being considered.

In the embodiment of FIG. 2, there are four different data sources 202. The bibliographic data accessed 204 from the different data sources 202 is generally in a source-specific format (e.g., source-specific data language and/or encoding, data encryption, data structure/schema, etc.). A standardization module 206 independently standardizes the accessed data 204 from each source in accordance with a common intermediate source-independent format, for example, dictated by an intermediate data structure or schema. The standardized format is applicable to the data from the different sources 202, such that similar data elements from distinct source-specific formats can be commonly identified within this intermediate format. This standardized data 208 is then further interpreted, via the common interpreter 210, in relation to stored database elements (e.g., existing data), which may comprise database elements derived from other sources, previous data versions or editions of a same source, etc., for populating the database in accordance with the relation, i.e., introducing any new or modified data resulting from this further interpretation into the database. The stored database elements can be stored in the data storage device 212. Some or all repetitive elements may be replaced with reference thereto during the interpretation from the intermediate data format. The repetitive elements, for example, may form part of a given source file and/or comprise stored elements.

As will be appreciated by a person of ordinary skill in the art, source data provided in distinct source-specific formats may be accessed from different or a same data repository, for example. Namely, data originating from a same data repository, for example generated, published and/or generally accessible from a same entity or organization, may in fact be provided in distinct source-specific formats, for example, as different versions of the same data (e.g., original vs. updated, revised and/or corrected versions), different editions (e.g., implementation of a new data format for later editions) and other such considerations may lead to distinctly formatted source data (e.g., distinct data representations, fields, codes, languages, etc.), thereby likely requiring distinct standardization protocols to achieve a common standardized intermediate format, even for different data sets accessed from a same or similar physical resources. As such, the method and system disclosed herein may be configured to accommodate such distinct source-specific formats, whether different sources are in fact effectively managed by a same or distinct entity. The person of skill in the art will appreciate that the entity or organization managing, publishing and/or generally providing access to a given data set, whether providing access to such data set in accordance with one or distinct data formats, may not be particularly relevant in the present context, and therefore, for the purpose of the following description, distinct sources and source-specific formats will be considered and defined irrespective of whether they are provided by a same or different originating entities. Clearly, it may be expected that different data formats originating from a same entity will, in some cases, share significant data format similarities; however, for the purpose of this description, where such similarities are insufficient to provide, once processed from a same standardization module, a same standardized output in accordance with a pre-defined intermediate data structure, distinct standardization modules will be considered for independently standardizing these similar, but distinct source-specific formats. Accordingly, in some embodiments, the database is populated with data from two or more sources, where one or more of the two or more sources reside at a same location or are made available by a same entity or service provider, for example, and provide data in different formats. In these embodiments, each different source residing at a same location, or made available by a same entity or the like, can be identified as a different source, providing data in a source-specific format. Conversely, different entities may provide access to distinct data sets in a same format, such that a same source-specific format is used by and accessed from two distinct entities. Accordingly, a same standardization module may be used for such distinct data sets, whereby standardization results are provided in same intermediate format for such distinct data sets. In such embodiments, data accessed from distinct entities or data service providers can be identified as a same source for the purpose of the following description, as implementation of the proposed database population method and system is generally blind to the data provider, but rather affected by the different formats in which the source data is provided.

In general, the common intermediate format is used for data coming from different sources, and is not yet in a format compliant with the structure of the database. For instance, the data is not fully interpreted by the standardization module, but rather is only transformed into a common intermediate format for further interpretation by a common interpreter. Namely, it is the standardized data that is interpreted by the interpreter in relation to stored database elements for populating the database in accordance with the relation, as dictated by the database data structure. With the intermediate data structure and the database data structure both being set, the interpretation step is generally the same for data derived from different sources and from different source-specific formats. Since data from more than one source, in different formats, is first standardized in accordance with a common intermediate format, relations or links to elements from different sources can be made more readily and efficiently than via the direct interpretation of the source format into database format, as shown in the known system of FIG. 1. Namely, the system of FIG. 2 provides a first transformation of the source-specific data into a source-independent intermediate format dictated by an intermediate data structure or schema that is common for data accessed from each source in each source-specific format. The interpreter then proceeds to further interpret this data consistent with a refined database data structure, which further interpretation can be implemented in a source-independent manner, which may result in greater processing efficiency, simplicity and/or a higher level of data integration without requiring some of the more complex data integration solutions discussed above. Namely, relationships between disparate source-specific schemas need not be defined, nor do different data sets need be interpreted simultaneously to allow for effective data cross-referencing. For instance, distinct source data may be processed independently, either in batches (i.e., processing bibliographic data related to tens, hundreds or thousands of documents at once) or individually (i.e., processing a single document of interest, and its related data, independently).

Furthermore, by decoupling each source-specific data structure from the destination data structure of the database, changes implemented in the source data structure, for example, in relation to new, revised and/or updated information provided by a same resource, may be accommodated by revising only the source-specific standardization module, as the intermediate data structure is not changed and therefore, the common interpreter may also remain unchanged. Conversely, if the database data structure is revised, only the common interpreter need be revised, each source-specific standardization module remaining unaltered by these revisions.

Also, it will be appreciated that, in some embodiments, by extracting only the information of interest from the source-specific formats for standardization consistent with an intermediate data structure (e.g., a subset of bibliographic data relevant to a given database application), only this information of interest, transformed in a common source-independent format, may be efficiently interpreted in relation to stored database elements, thereby resulting in an efficient overall multi-source database population method. Conversely, accessing distinct source data relevant to different sections of the database structure, may be more readily transformed in the intermediate format for direct interpretation within this particular section of the database structure while allowing for appropriate relations to be established with data from other sections of the database structure (e.g., document classification codes and descriptors may be integrated for ready association with documents citing such classification codes).

As will also be appreciated by the person of ordinary skill in the art, the method and system of the present disclosure may allow for refinement of the intermediate data structure in normalizing the data for integration within a refined database structure. For example, while the intermediate data structure may be configured to provide only minimal normalization (e.g., normalization to the first normal form, for example) given its intermediate status, further normalization may then be implemented upon interpreting this intermediate data in relation to stored database elements, which may be normalized to the third or higher normal form, as appropriate. Moreover, this approach may avoid full direct normalization of source data in a first iteration, where such data would then need to be fully renormalized with respect to previously stored database elements. Accordingly, a normalization of the database data structure may be higher than that of the intermediate data structure. Furthermore, upon refinement of the intermediate data for compliance with the database data structure, in some embodiments, the need for post database population data processing, for example, such as data filtering, cleaning and the like (e.g., to remove duplicates, erroneous entries, etc.) is reduced or avoided. The person of ordinary skill in the art will appreciate that other considerations may apply in refining the intermediate data for compliance with the destination database data structure, leading to similar advantages over the state of the art.

In some embodiments, the standardized data is interpreted in relation to stored database elements as well as to other elements within the standardized data. For example, not only can elements that are repetitive with stored database elements be replaced with references to the repetitive database elements, but if the accessed data itself, and therefore the standardized data, contain repetitive elements, they may also be replaced with references to said elements. It will be apparent to a person of skill in the art that stored database elements can be updated or replaced with more up-to-date or complete data during population.

Furthermore, and in accordance with one embodiment, the interpreting step may be configured to interpret similar data elements associated with distinct documents as identical, e.g., in order to replace occurrence of such identical elements with reference thereto, based on a degree of similarity between other data elements associated with these documents. For example, while two documents may list authors having the same first and last name, for example, which bibliographic data elements are commonly identified within the intermediate data format, these authors are only identified as identical authors provided complementary data is also found as sufficiently similar for these author entries. For example, two authors sharing the same first and last name, nationality and city of residence may be considered identical in one embodiment, whereas distinctly identified cities of residence may be sufficient to maintain a distinction between two commonly named authors. These and other such interpretation rules may be considered herein without departing from the general scope and nature of the present disclosure, as will be apparent to the person of ordinary skill in the art in applying the method and system described herein to a particular application.

As will be appreciated by a person of skill in the art, the data accessed from different sources can be processed in parallel, sequentially, or in another order. For example, a database may be updated regularly from all applicable sources at once, and/or periodically on a revolving schedule which, for example, is defined by an updated availability of source data provided by each source independently. The data accessed from a data source may be a single file or multiple/batch files. Accessed data may be parsed for relevant or desired elements prior to or during interpretation. In some embodiments, population of the database is carried out automatically, with the system downloading the files from one or more sources and automatically transforming it into the intermediate standard for interpreting and populating the database. In some embodiments, files are downloaded from sources on a pre-determined schedule. The schedule may be based on the timing of updating of the respective data sources. Population may also be instigated manually or semi-automatically.

In one embodiment, the accessed data may be in XML. In some other embodiments, it may be turned into XML for or by the standardization module. In another embodiment, the accessed data may be in CSV, or again turned into CSV for or by the standardization module. As will be appreciated by a person of skill in the art, the accessed data may be in different languages or structures, as can the resulting standardized data.

In one embodiment, at least some of the accessed data is standardized by first reading the accessed data in its source-specific format, and associating each read data element thereof, as applicable, with a corresponding standardized element (e.g., data category, class, reference, item, entry, etc.) available in the common intermediate standardized format. Namely, in such standardization, a relevant standardization module or the like is configured to read and understand the data elements of the source-specific format for association with corresponding elements of the common standardized format.

In a same or alternative embodiment, at least some of the accessed data is standardized by instead reading available elements (e.g. data category, class, reference, item, entry, etc.) from the common standardized format and retrieving corresponding data elements in its source-specific format from the accessed data. Accordingly, such a process involves a reading and understanding of the common standardized format and retrieval of corresponding and available data elements from the source-specific format.

In one such embodiment where, at least for one of the data sources, the accessed data is provided and formatted in accordance with a source-specific extended markup language (XML) format, the associated standardization module can be implemented via Extensible Stylesheet Language Transformations (XSLT). Namely, the source-specific XML format can be standardized via XSLT to provide the common standardized intermediate format, which may be in XML, or formatted using an alternative language more suitable for downstream interpretation (e.g., hypertext markup language—HTML, etc.) These and other such transformation protocols will be readily known to the person of ordinary skill in the art and should thus be considered herein as exemplary rather than in a limiting fashion.

In one embodiment, one or more standardization modules are encoded and/or comprise statements and instructions for combining data from a given source-specific format to comply with the common standardized format. For example, in one embodiment where accessed data provides patent-related data, distinct data elements in the source-specific format may be provided to identify the document country and document serial number, whereas the common standardized format may rather require a combination of such elements to provide the document serial number in a country-specific manner. For example, U.S. patent application Ser. No. 10/111,111 may be provided in the source-specific format as two distinct entries <country>US</country> and <ser-number>10/111,111</ser-number>, whereas the standardized format may rather provide for the following format: <serial-num>US 10/111,1111</serial-num>, thereby combining both data entries. In some embodiments, and following from the same example, a same source-specific data element may be utilized repetitively to comply with the standardized format, e.g., the country code in the source-specific format could be used in the standardized format in combination with an application serial number entry, alone for a country code entry (which may be in the same format, e.g., US, or in an alternate format, e.g., United States), and/or for other entries as appropriate when considered useful in downstream interpretation of the standardized format. Accordingly, data standardization may include one-to-one associations, one-to-many associations and/or combinations, many-to-one associations and/or combinations, and/or many-to-many associations and/or combinations. It will be appreciated that while the above is provided in an XML-type format, the embodiments of the invention herein described should in no way be limited to such language, as will be readily appreciated by the person of ordinary skill in the art.

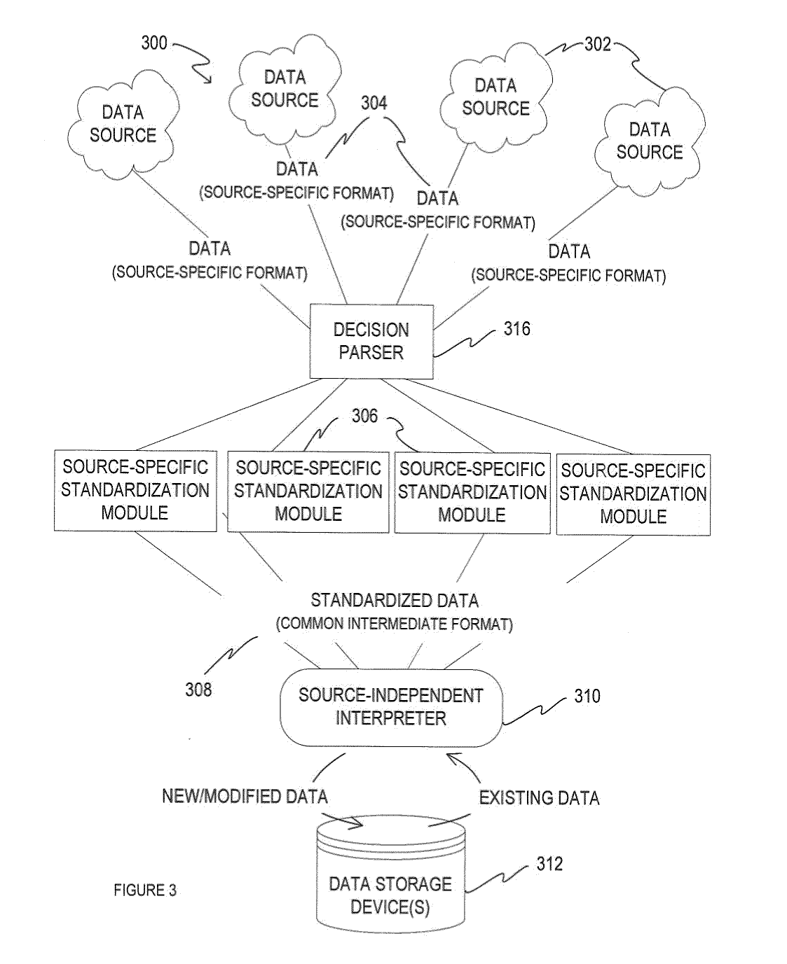

FIG. 3 is a schematic representation of a system 300 for populating a database with data from different sources 302, according to another embodiment of the invention. In this embodiment, the accessed data 304 is treated with a decision parser 316 which determines which standardization module 306 to use for the standardization of the data format. The standardized data 308 is then interpreted, by the interpreter 310, in relation to stored database elements (e.g., existing data) for population of the database in accordance with the relation. The stored database elements can be stored in the data storage device 312.

The database can comprise the data storage device and, in some embodiments, the interpreter. In some embodiments, one or more of the standardization modules also form part of the database. In embodiments comprising a decision parser, it may or may not form part of the database.

As will be apparent to a person of skill in the art, the system can be self-contained, or different components or functions can be remote. For example, the standardization modules can be located in one place, and the interpreter and data storage device can be located in another. The standardization modules may also be located separately or in one place, as well as the interpreter and data storage device. The data storage device and/or interpreter may also have remote functionality. As will be appreciated by a person of skill in the art, various local, distributed, networked and/or other such system architectures may be considered herein, for example, interconnected via various communication mediums (e.g., Internet, Ethernet, LAN, etc.) using various communication algorithms and/or protocols, without departing from the general scope and nature of the present disclosure.

In one embodiment, the system may further be accessed internally and/or externally by one or more computing devices configured to provide a user interface, e.g., via an appropriate monitor and a user data access platform (e.g., application program interface or the like providing structured and organized access to stored data, such as a local or networked desktop application, web-based application, and the like) so to enable viewing, searching, retrieving, sorting, classification, extraction and/or other such user manipulations and consumption of the interpreted data, and interrelations therebetween. Such access may be provided, for example, via a desktop, laptop and/or palmtop computing device, which may be local to the system (e.g., comprising some or all the processing devices and data storage media related to the standardization modules and interpreter), regional (e.g., comprising some local or regional network interconnection to some of the system's modules and components) or remote (e.g., comprising remote network capabilities via one or more public, proprietary, private and/or secure network connections).

As will be appreciated by the person skilled in the art, the various components and/or modules of different embodiments of the invention may be implemented via different computational platforms, devices and the like. For example, different modules may be implemented by same or distinct computing platforms enabling the manipulation and exchange of data in different formats and supported by one or more data storage devices, processors and the like. Furthermore, administrative access to such modules can be provided via one more user interfaces (e.g., local and/or remote peripheral devices such as monitors, keyboards, printers, etc.) enabling not only manipulation and/or rectification of data and modules themselves through the process, but also to gain access to the finalized product, e.g., the stored and interrelated interpreted data elements.

In one embodiment, the database generally is a relational database which can be normalized to various forms. For example, it will be appreciated by a person of skill in the art that the database can be normalized to the first, second, third or higher normal forms in order to efficiently organize the data in the database and eliminate or reduce redundant data by replacing some or all repetitive elements with reference thereto.

In one embodiment, the data can include metadata. In some embodiments the database is populated, at least in part, based on interrelations between the various elements of the metadata.

In one embodiment, the database is a document database and includes metadata related to the documents, as well as the documents themselves. In one embodiment, the documents are publications and the metadata may include the date of publication, author(s), language, type of publication, etc.

In one embodiment, the database is a patent database. In this embodiment the metadata may include the status of the application (published, abandoned, issued patent, etc), various dates such as the filing and publication dates, priority data, cited prior art, and the like. The various relations between the data for each patent or patent application may be used to populate the database. Links may be established between metadata and other patents, for example.

In one embodiment, the database is a fully relational database normalized to third normal form, with repetitive data replaced with references to said data. For example, in a patent database application, if five patents in a single dataset are classified to the same class code, such as H01L-015/32, the accessed data from the data source as well as the standardized data would comprise five instances of this data element. Following interpretation and population, a single H01L-015/32 element will be stored in the database comprising links thereto from patents related to this class. This many-to-many relationship can be implemented using a linking table with one-to-many relationships to both patents and classes. It is also possible, for example, to download data from WIPO detailing the hierarchy of IPC class codes, along with titles and the like, such that the database also contains information about the code, such as its parent code, any child codes, and the title/description of the code. In this manner, the five patents can be linked to more data than available from a single source.

In another example of a relational patent database according to one embodiment, the standardized data is interpreted in relation to stored database elements comprising patents for populating the database in accordance with this relation. For example, if accessed data comprises a patent citing another patent which is already in the database as a stored database element (i.e., because it was contained within previously accessed data), the database can be populated in accordance with this relation. The accessed data comprises little or no information about the cited patent other than the patent number, for example. However, due to the database being populated in accordance with this relation, the records for the patent from the accessed data and its cited patent of a stored database element are linked. Since they are linked in the database, a forward citation analysis on the cited patent is straightforward, whereas without this linking, a database would have to be searched for all references to the cited patent. In this example, a forward citation analysis is as simple as a backward citation analysis. Since accessed data is first standardized into a common intermediate standardized format and then interpreted in relation to stored database elements for populating the database in accordance with said relation with at least some repetitive elements replaced with reference thereto, the database can comprise useful links. For example, if one data source provides a U.S. patent which cites an EP patent that is already in the database, having been derived from another source, this database population method, involving interpreting this data from a standardized format in relation to stored database elements, allows for these two documents to be linked within the database in an efficient manner. In this manner, a database user would not need to search the database for the EP patent cited by the U.S. patent, as the two would already be linked within the database.

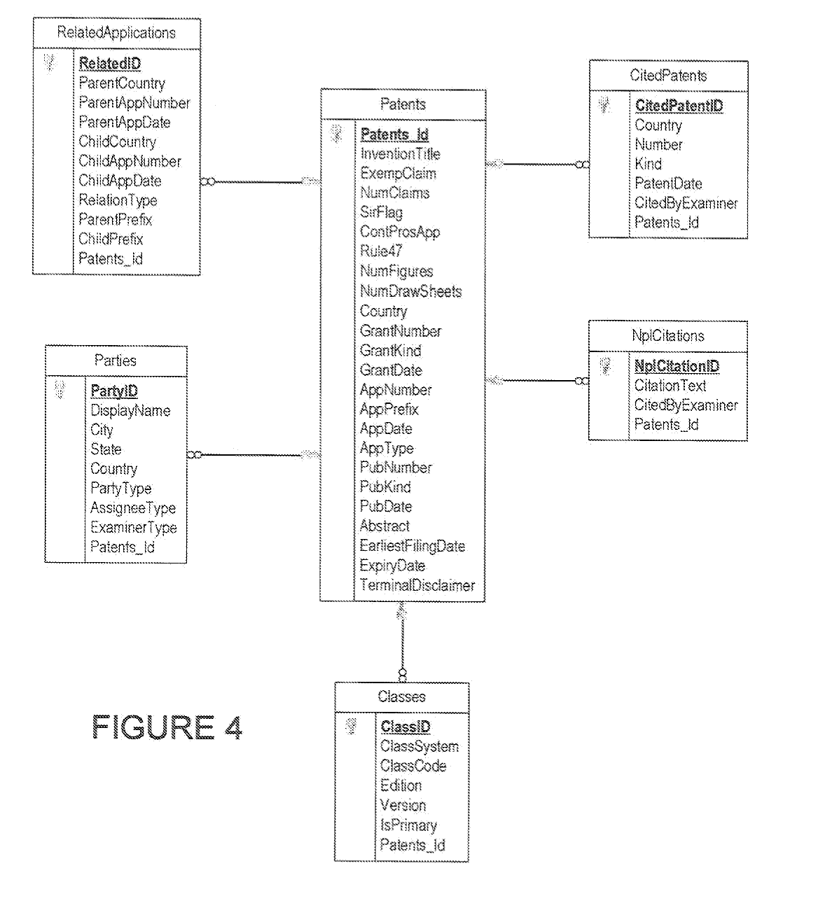

FIG. 4 gives an example of a portion of a standardized intermediate data structure applicable in the context of a relational patent database according to one embodiment. This standardized data structure comprises simple one-to-many relationships between patents and classes. One patent may have multiple classes, but each class belongs to only one patent. If there are multiple patents referring to a given class code, there will be multiple repetitive entries in the classes table, each pointing to a different patent.

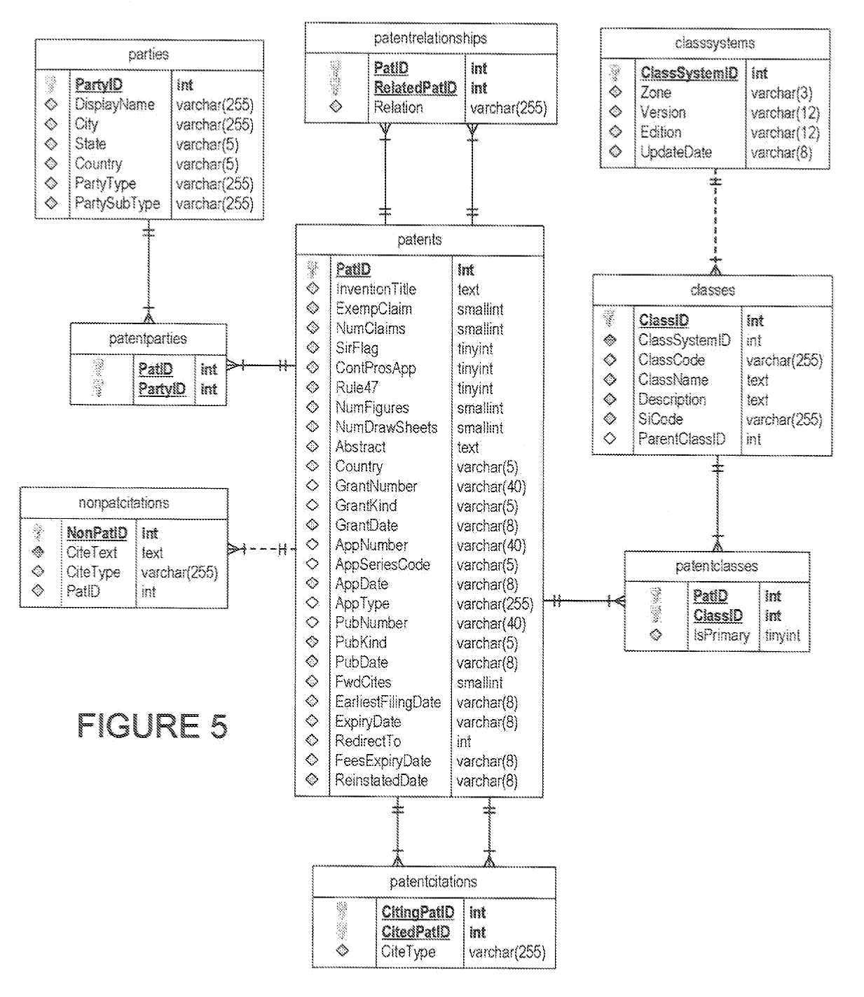

FIG. 5 gives an example of a portion of an interpreted refined database structure of a relational patent database according to one embodiment. The tables of this normalized data structure show the many-to-many relationship between patents and classes, via the linking table PatentClasses. The classes table has additional information, such as parent-child relationships and class names. PatentCitations is another linking table, creating a many-to-many relationship between Patents and Patents, including links between patents and their cited patents, for example.

Examples of relevant data formats for a method of populating a relational patent database according to one embodiment are provided below. The following is the response from the European Patent Office's Open Patent Services web service, in response to a request for data on EP 1000000. The accessed data is in a source-specific format.

```
<WORLDPATENTDATA>
<BIBLIO Seed=“EP1000000” Seed_Format=“E” Seed_Type=“PN”>
<SDOBI>
    <B111EP DATE=“20000517”>EP1000000</B111EP>
    <B131EP>A1</B131EP>
    <B211EP DATE=“19991108”>EP19990203729</B211EP>
    <B211EP TYPE=“original” DATE=“”>99203729</B211EP>
    <B311EP DATE=“19981112”>NL19981010536</B311EP>
    <B311EP TYPE=“original” DATE=“”>1010536</B311EP>
    <B510 TYPE=“EPC”>H02P6/08; B28B1/29; B28B5/02B2; B28B7/00F</B510>
    <B510 TYPE=“IPC”>B28B5/02; B28B1/29; B28B7/00</B510>
    <B510 TYPE=“CI”>B28B1/00; B28B5/00; B28B7/00; H02P6/08</B510>
    <B510 TYPE=“AI”>B28B1/29; B28B5/02; B28B7/00; H02P6/08</B510>
    <B542 TYPE=“TI”>Apparatus for manufacturing green bricks for the brick
manufacturing industry</B542>
    <B542 TYPE=“OT”>Vorrichtung zur Herstellung von Steinformlingen für die
Ziegelindustrie</B542>
    <B542 TYPE=“OT”>Dispositif pour la fabrication de briques crues utilisées dans
l'industrie manufacturière des briques</B542>
    <B560 TYPE=“PAT”>EP0680812 A1 [A]; NL9400663 A [A];DE3546191 A1
[A]</B560>
    <B570EP>The invention relates to an apparatus (1) for manufacturing green
bricks from clay for the brick manufacturing industry, comprising a circulating
conveyor (3) carrying mould containers combined to mould container parts (4), a
reservoir (5) for clay arranged above the mould containers, means for carrying clay
out of the reservoir (5) into the mould containers, means (9) for pressing and
trimming clay in the mould containers, means (11) for supplying and placing take-
off plates for the green bricks (13) and means for discharging green bricks released
from the mould containers, characterized in that the apparatus further comprises
means (22) for moving the mould container parts (4) filled with green bricks such
that a protruding edge is formed on at least one side of the green bricks.
<IMAGE></B570EP>
    <B711EP>BOER BEHEER NIJMEGEN BV DE (NL)</B711EP>
    <B711EP TYPE=“original”>BEHEERMAATSCHAPPIJ DE BOER NIJMEGEN
B.V</B711EP>
    <B721EP>KOSMAN WILHELMUS JACOBUS MARIA (NL)</B721EP>
    <B721EP TYPE=“original”>KOSMAN, WILHELMUS JACOBUS
MARIA</B721EP>
    </SDOBI>
    </BIBLIO>
<BIBLIO Seed=“EP1000000” Seed_Format=“E” Seed_Type=“PN”>
<SDOBI>
    <B111EP DATE=“20030212”>EP1000000</B111EP>
    <B131EP>B1</B131EP>
    <B211EP DATE=“19991108”>EP19990203729</B211EP>
    <B211EP TYPE=“original” DATE=“”>99203729</B211EP>
    <B311EP DATE=“19981112”>NL19981010536</B311EP>
    <B311EP TYPE=“original” DATE=“”>1010536</B311EP>
    <B510 TYPE=“EPC”>H02P6/08; B28B1/29; B28B5/02B2; B28B7/00F</B510>
    <B510 TYPE=“IPC”>B28B5/02; B28B1/29; B28B7/00</B510>
    <B510 TYPE=“CI”>B28B1/00; B28B5/00; B28B7/00; H02P6/08</B510>
    <B510 TYPE=“AI”>B28B1/29; B28B5/02; B28B7/00; H02P6/08</B510>
    <B542 TYPE=“TI”>Apparatus for manufacturing green bricks for the brick
manufacturing industry</B542>
    <B542 TYPE=“OT”>Vorrichtung zur Herstellung von Steinformlingen für die
Ziegelindustrie</B542>
    <B542 TYPE=“OT”>Dispositif pour la fabrication de briques crues utilisées dans
l'industrie manufacturière des briques</B542>
    <B711EP>BEHEERMIJ DE BOER NIJMEGEN B V (NL)</B711EP>
    <B711EP TYPE=“original”>BEHEERMAATSCHAPPIJ DE BOER NIJMEGEN
B.V</B711EP>
    <B721EP>KOSMAN WILHELMUS JACOBUS MARIA (NL)</B721EP>
    <B721EP TYPE=“original”>KOSMAN, WILHELMUS JACOBUS
MARIA</B721EP>
    </SDOBI>
    </BIBLIO>
    </WORLDPATENTDATA>
```

The following is the standardized intermediate data resulting from standardizing the above accessed data in accordance with a common intermediate standardized format according to this embodiment. This format is applicable to data from other sources, for example, and in this embodiment it is also applicable to the United States Patent and Trademark Office FTP server.

```
<?xml version=“1.0” encoding=“utf-8” ?>
<AllPatents version=“SI 1.0”>
    −<Patents>
          <InventionTitle>Apparatus for manufacturing green bricks for the brick
        manufacturing industry</InventionTitle>
        <ExempClaim>0</ExempClaim>
        <NumClaims>0</NumClaims>
        <SirFlag>0</SirFlag>
        <ContProsApp>0</ContProsApp>
        <Rule47>0</Rule47>
        <TerminalDisclaimer>0</TerminalDisclaimer>
        <NumFigures>0</NumFigures>
        <NumDrawSheets>0</NumDrawSheets>
        <Country>EP</Country>
        <AppNumber>99203729</AppNumber>
        <AppPrefix />
        <AppDate>19991108</AppDate>
        <AppType>UNKNOWN</AppType>
        −<Parties>
            <DisplayName>BEHEERMAATSCHAPPIJ DE BOER NIJMEGEN
            B.V</DisplayName>
            <City />
            <State />
            <Country>NL</Country>
            <PartyType>ASSIGNEE</PartyType>
            <AssigneeType>UNKNOWN</AssigneeType>
            <ExaminerType>NON_EXAMINER</ExaminerType>
        </Parties>
        −<Parties>
            <DisplayName>KOSMAN, WILHELMUS JACOBUS
            MARIA</DisplayName>
            <City />
            <State />
            <Country>NL</Country>
            <PartyType>APPLICANT</PartyType>
            <AssigneeType>NON_ASSIGNEE</AssigneeType>
            <ExaminerType>NON_EXAMINER</ExaminerType>
        </Parties>
        −<Classes>
            <ClassSystem>IPC</ClassSystem>
            <ClassCode>B28B-001/29</ClassCode>
            <Version>8</Version>
            <Edition>20070101</Edition>
            <ClassName />
            <ParentClassID>0</ParentClassID>
            <IsPrimary>1</IsPrimary>
        </Classes>
        −<Classes>
            <ClassSystem>IPC</ClassSystem>
            <ClassCode>B28B-005/02</ClassCode>
              <Version>8</Version>
            <Edition>20070101</Edition>
              <ClassName />
            <ParentClassID>0</ParentClassID>
              <IsPrimary>0</IsPrimary>
        </Classes>
        −<Classes>
            <ClassSystem>IPC</ClassSystem>
            <ClassCode>B28B-007</ClassCode>
            <Version>8</Version>
            <Edition>20070101</Edition>
            <ClassName />
              <ParentClassID>0</ParentClassID>
              <IsPrimary>0</IsPrimary>
        </Classes>
        −<Classes>
            <ClassSystem>IPC</ClassSystem>
            <ClassCode>H02P-006/08</ClassCode>
            <Version>8</Version>
            <Edition>20070101</Edition>
            <ClassName />
            <ParentClassID>0</ParentClassID>
            <IsPrimary>0</IsPrimary>
        </Classes>
        −<Classes>
            <ClassSystem>EPC</ClassSystem>
            <ClassCode>H02P-006/08</ClassCode>
            <Version>0</Version>
            <Edition>0</Edition>
            <ClassName />
            <ParentClassID>0</ParentClassID>
            <IsPrimary>1</IsPrimary>
        </Classes>
        −<Classes>
            <ClassSystem>EPC</ClassSystem>
            <ClassCode>B28B-001/29</ClassCode>
            <Version>0</Version>
            <Edition>0</Edition>
            <ClassName />
            <ParentClassID>0</ParentClassID>
            <IsPrimary>0</IsPrimary>
        </Classes>
        −<Classes>
            <ClassSystem>EPC</ClassSystem>
            <ClassCode>B28B-005/02.B2</ClassCode>
            <Version>0</Version>
            <Edition>0</Edition>
            <ClassName />
            <ParentClassID>0</ParentClassID>
            <IsPrimary>0</IsPrimary>
        </Classes>
        −<Classes>
            <ClassSystem>EPC</ClassSystem>
            <ClassCode>B28B-007/00.F</ClassCode>
            <Version>0</Version>
            <Edition>0</Edition>
            <ClassName />
            <ParentClassID>0</ParentClassID>
            <IsPrimary>0</IsPrimary>
        </Classes>
        −<RelatedApplications>
            <ParentCountry>NL</ParentCountry>
            <ParentAppNumber>1010536</ParentAppNumber>
            <ParentAppDate>19981112</ParentAppDate>
            <ChildCountry>EP</ChildCountry>
            <ChildAppNumber>99203729</ChildAppNumber>
            <ChildAppDate>19991108</ChildAppDate>
            <RelationType>FOREIGN_PRIORITY</RelationType>
        </RelatedApplications>
        <EarliestFilingDate>19991108</EarliestFilingDate>
        <ExpiryDate>20191108</ExpiryDate>
        <GrantNumber>1000000</GrantNumber>
        <GrantKind>B1</GrantKind>
        <GrantDate>20030212</GrantDate>
        <PubNumber>1000000</PubNumber>
        <PubDate>20000517</PubDate>
        <PubKind>A1</PubKind>
        <Abstract>The invention relates to an apparatus (1) for manufacturing green
bricks from clay for the brick manufacturing industry, comprising a circulating
conveyor (3) carrying mould containers combined to mould container parts (4), a
reservoir (5) for clay arranged above the mould containers, means for carrying clay
out of the reservoir (5) into the mould containers, means (9) for pressing and
trimming clay in the mould containers, means (11) for supplying and placing take-
off plates for the green bricks (13) and means for discharging green bricks released
from the mould containers, characterized in that the apparatus further comprises
means (22) for moving the mould container parts (4) filled with green bricks such
that a protruding edge is formed on at least one side of the green bricks.
<IMAGE></Abstract>
    </Patents>
</AllPatents>
```

The above standardized intermediate data is interpreted in relation to stored database elements comprising database elements derived from at least another source, for populating the database in accordance with said relation with at least some repetitive elements replaced with reference to said repetitive elements. The data populated in the database is normalized in accordance with a refined database data structure. While it generally exists only in the database, the following is an approximation of the corresponding data in the database, exported back to an XML file.

```
<?xml version=“1.0” standalone=“yes” ?>
<PatentDB xmlns=“http://tempuri.org/PatentDB.xsd”>
−<Patents>
    <PatID>−1</PatID>
    <InventionTitle>Apparatus for manufacturing green
bricks for the brick manufacturing industry</InventionTitle>
    <ExempClaim>0</ExempClaim>
    <NumClaims>0</NumClaims>
    <SirFlag>false</SirFlag>
    <ContProsApp>false</ContProsApp>
    <Rule47>false</Rule47>
    <NumFigures>0</NumFigures>
    <NumDrawSheets>0</NumDrawSheets>
    <Abstract>The invention relates to an apparatus (1) for manufacturing
green bricks from clay for the brick manufacturing industry, comprising a
circulating conveyor (3) carrying mould containers combined to mould
container parts (4), a reservoir (5) for clay arranged above the mould
containers, means for carrying clay out of the reservoir (5) into the
mould containers, means (9) for pressing and trimming clay in the mould
containers, means (11) for supplying and placing take-off plates for the
green bricks (13) and means for discharging green bricks released
from the mould containers, characterized in that the apparatus further
comprises means (22) for moving the mould container parts (4) filled with
green bricks such that a protruding edge is formed on at least one side of
the green bricks.
<IMAGE></Abstract>
    <Country>EP</Country>
    <GrantNumber>1000000</GrantNumber>
    <GrantKind>B1</GrantKind>
    <GrantDate>20030212</GrantDate>
    <AppNumber>99203729</AppNumber>
    <AppPrefix />
    <AppDate>19991108</AppDate>
    <AppType>UNKNOWN</AppType>
    <PubNumber>1000000</PubNumber>
    <PubKind>A1</PubKind>
    <PubDate>20000517</PubDate>
    <TerminalDisclaimer>false</TerminalDisclaimer>
</Patents>
−<Patents>
    <PatID>−2</PatID>
    <Country>NL</Country>
    <AppNumber>1010536</AppNumber>
    <AppPrefix />
    <AppDate>19981112</AppDate>
    <TerminalDisclaimer>false</TerminalDisclaimer>
</Patents>
−<Parties>
    <PartyID>−1</PartyID>
    <DisplayName>BEHEERMAATSCHAPPIJ DE BOER NIJMEGEN
B.V</DisplayName>
    <City />
    <State />
    <Country>NL</Country>
    <PartyType>ASSIGNEE</PartyType>
    <AssigneeType>UNKNOWN</AssigneeType>
</Parties>
−<Parties>
    <PartyID>−2</PartyID>
    <DisplayName>KOSMAN, WILHELMUS JACOBUS MARIA
    </DisplayName>
    <City />
    <State />
    <Country>NL</Country>
    <PartyType>APPLICANT</PartyType>
    <AssigneeType>NON_ASSIGNEE</AssigneeType>
</Parties>
−<PatentParties>
    <PatID>−1</PatID>
    <PartyID>−1</PartyID>
    <ExaminerType>NON_EXAMINER</ExaminerType>
</PatentParties>
−<PatentParties>
    <PatID>−1</PatID>
    <PartyID>−2</PartyID>
    <ExaminerType>NON_EXAMINER</ExaminerType>
</PatentParties>
−<Classes>
    <ClassID>−1</ClassID>
    <ClassCode>B28B-001/29</ClassCode>
    <Edition>20070101</Edition>
    <Version>8</Version>
    <ClassSystem>IPC</ClassSystem>
</Classes>
−<Classes>
    <ClassID>−2</ClassID>
    <ClassCode>B28B-005/02</ClassCode>
    <Edition>20070101</Edition>
    <Version>8</Version>
    <ClassSystem>IPC</ClassSystem>
</Classes>
−<Classes>
    <ClassID>−3</ClassID>
    <ClassCode>B28B-007</ClassCode>
    <Edition>20070101</Edition>
    <Version>8</Version>
    <ClassSystem>IPC</ClassSystem>
</Classes>
−<Classes>
    <ClassID>−4</ClassID>
    <ClassCode>H02P-006/08</ClassCode>
    <Edition>20070101</Edition>
    <Version>8</Version>
    <ClassSystem>IPC</ClassSystem>
</Classes>
−<Classes>
    <ClassID>−5</ClassID>
    <ClassCode>H02P-006/08</ClassCode>
    <Edition>0</Edition>
    <Version>0</Version>
    <ClassSystem>EPC</ClassSystem>
</Classes>
−<Classes>
    <ClassID>−6</ClassID>
    <ClassCode>B28B-001/29</ClassCode>
    <Edition>0</Edition>
    <Version>0</Version>
    <ClassSystem>EPC</ClassSystem>
</Classes>
−<Classes>
    <ClassID>−7</ClassID>
    <ClassCode>B28B-005/02.B2</ClassCode>
    <Edition>0</Edition>
    <Version>0</Version>
    <ClassSystem>EPC</ClassSystem>
</Classes>
−<Classes>
    <ClassID>−8</ClassID>
    <ClassCode>B28B-007/00.F</ClassCode>
    <Edition>0</Edition>
    <Version>0</Version>
    <ClassSystem>EPC</ClassSystem>
</Classes>
−<PatentClasses>
    <PatID>−1</PatID>
    <ClassID>−1</ClassID>
</PatentClasses>
−<PatentClasses>
    <PatID>−1</PatID>
    <ClassID>−2</ClassID>
</PatentClasses>
−<PatentClasses>
    <PatID>−1</PatID>
    <ClassID>−3</ClassID>
</PatentClasses>
−<PatentClasses>
    <PatID>−1</PatID>
    <ClassID>−4</ClassID>
</PatentClasses>
−<PatentClasses>
    <PatID>−1</PatID>
    <ClassID>−5</ClassID>
</PatentClasses>
−<PatentClasses>
    <PatID>−1</PatID>
    <ClassID>−6</ClassID>
</PatentClasses>
−<PatentClasses>
    <PatID>−1</PatID>
    <ClassID>−7</ClassID>
</PatentClasses>
−<PatentClasses>
    <PatID>−1</PatID>
    <ClassID>−8</ClassID>
</PatentClasses>
−<PatentRelations>
    <ParentPatID>−2</ParentPatID>
    <ChildPatID>−1</ChildPatID>
    <RelationType>FOREIGN_PRIORITY</RelationType>
</PatentRelations>
</PatentDB>
```

As discussed above, different embodiments of the invention may be applied to different types of bibliographic data, for example, to interrelated document-related data associated with documents from different types of document-based collections. For example, while the above is applied to patent database collections, the following example is directed to general publications, including books and/or articles, and bibliographic data related therewith. In this next example, source-specific data formats are not provided as the person of ordinary skill in the art will appreciate, particularly following the above example, different source-specific formats in which sourced data may be provided. Rather, the below example first provides juxtaposed standardized intermediate data accessed from different sources and independently standardized in accordance with a common intermediate source-independent format.

```
<?xml version=“1.0” encoding=“utf-8” ?>
−<LiteraryWorks>
    −<Work type=“book” id=“DA25674”>
        <Title>Hitchhiker's Guide to the Galaxy</Title>
        −<Author>
            −<Name>
                <LastName>Adams</LastName>
                <FirstName>Douglas</FirstName>
                <MiddleName />
                <Suffix />
                <Prefix />
                <Salutory>Mr.</Salutory>
            </Name>
        </Author>
        <PublicationDate>2005-04-01</PublicationDate>
        <Country>UK</Country>
        <Publisher>Pan Books</Publisher>
        −<Binding type=“hardcover”>
            <NumberOfPages>224</NumberOfPages>
        </Binding>
        <IdentityNumber type=“ISBN-10”>0330437984
        </IdentityNumber>
        <IdentityNumber type=“ISBN-13”>978-0330437981
        </IdentityNumber>
        <OriginalEdition id=“DA091921” />
    </Work>
    −<Work type=“book” id=“DA17531”>
        <Title>Hitchhiker's Guide to the Galaxy</Title>
        −<Author>
            −<Name>
                <LastName>Adams</LastName>
                <FirstName>Douglas</FirstName>
                <MiddleName />
                <Suffix />
                <Prefix />
                <Salutory>Mr.</Salutory>
            </Name>
        </Author>
        <PublicationDate>1979-10-12</PublicationDate>
        <Country>UK</Country>
        <Publisher>Pan Books</Publisher>
        −<Binding type=“paperback”>
            <NumberOfPages>180</NumberOfPages>
        </Binding>
        <IdentityNumber type=“ISBN-10”>0-330-25864-8
        </IdentityNumber>
        <Container type=“series” id=“1D838195R” order=“1” />
    </Work>
    −<Work type=“book” id=“DA18173”>
        <Title>The Restaurant at the End of the Universe</Title>
        <Author>
            −<Name>
                <LastName>Adams</LastName>
                <FirstName>Douglas</FirstName>
                <MiddleName />
                <Suffix />
                <Prefix />
                <Salutory>Mr.</Salutory>
            </Name>
        </Author>
        <PublicationDate>1980-01-01</PublicationDate>
        <Country>UK</Country>
        <Publisher>Pan Macmillan</Publisher>
        −<Binding type=“paperback”>
            <NumberOfPages>208</NumberOfPages>
        </Binding>
        <IdentityNumber type=“ISBN-10”>0-345-39181-0
        </IdentityNumber>
        <Container type=“series” id=“1D838195R” order=“2” />
    </Work>
    −<Work type=“book” id=“DA18230”>
        <Title>Life, the Universe and Everything</Title>
        <Author>
            −<Name>
                <LastName>Adams</LastName>
                <FirstName>Douglas</FirstName>
                <MiddleName />
                <Suffix />
                <Prefix />
                <Salutory>Mr.</Salutory>
            </Name>
        </Author>
        <PublicationDate>1982-01-01</PublicationDate>
        <Country>UK</Country>
        <Publisher>Pan Books</Publisher>
        −<Binding type=“paperback”>
            <NumberOfPages>160</NumberOfPages>
        </Binding>
        <IdentityNumber type=“ISBN-10”>0-330-26738-8
        </IdentityNumber>
        <Container type=“series” id=“1D838195R” order=“3” />
    </Work>
    −<Work type=“book” id=“DA19291”>
        <Title>So Long, and Thanks for All the Fish</Title>
        −<Author>
            −<Name>
                <LastName>Adams</LastName>
                <FirstName>Douglas</FirstName>
                <MiddleName />
                <Suffix />
                <Prefix />
                <Salutory>Mr.</Salutory>
            </Name>
        </Author>
        <PublicationDate>1984-01-01</PublicationDate>
        <Country>UK</Country>
        <Publisher>Pan Books</Publisher>
        −<Binding type=“paperback”>
            <NumberOfPages>192</NumberOfPages>
        </Binding>
        <IdentityNumber type=“ISBN-10”>0-330-28700-1
        </IdentityNumber>
        <Container type=“series” id=“1D838195R” order=“4” />
    </Work>
    −<Work type=“journal” id=“PW1840912”>
        <Title>TechNet</Title>
        <Author>Microsoft Corporation</Author>
        <PublicationDate>2009-07-01</PublicationDate>
        <Country>US</Country>
        <Publisher>United Business Media LLC</Publisher>
        −<Editor>
            −<Name>
                <LastName>Hoffman</LastName>
                <FirstName>Joshua</FirstName>
                <MiddleName />
                <Suffix />
                <Prefix />
                <Salutory>Mr.</Salutory>
            </Name>
        </Editor>
        −<Editor>
            −<Name>
                <LastName>Graven</LastName>
                <FirstName>Matthew</FirstName>
                <MiddleName />
                <Suffix />
                <Prefix />
                <Salutory>Mr.</Salutory>
            </Name>
        </Editor>
        −<Editor>
            −<Name>
                <LastName>Terdeman</LastName>
                <FirstName>Sharon</FirstName>
                <MiddleName />
                <Suffix />
                <Prefix />
                <Salutory>Ms.</Salutory>
            </Name>
        </Editor>
        −<Binding type=“paperback”>
            <NumberOfPages>64</NumberOfPages>
        </Binding>
        <IdentityNumber type=“ISSN”>1551-2770</IdentityNumber>
        −<Volumes>
            <VolumeNumber>5</VolumeNumber>
            <Edition>7</Edition>
        </Volumes>
    </Work>
    −<Work type=“article” id=“TN283912”>
        <Title>Inside Windows 7 User Account Control</Title>
        −<Author>
            −<Name>
                <LastName>Russinovich</LastName>
                <FirstName>Mark</FirstName>
                <MiddleName />
                <Suffix />
                <Prefix />
                <Salutory>Mr.</Salutory>
            </Name>
        </Author>
        <PublicationDate>2009-07-01</PublicationDate>
        <Country>US</Country>
        <Publisher>United Business Media LLC</Publisher>
        −<Binding type=“paperback”>
            <NumberOfPages>7</NumberOfPages>
        </Binding>
        <Container type=“journal” id=“PW1840912” />
    </Work>
    −<Work type=“series” id=“1D838195R”>
        <Work type=“book” id=“DA17531” />
        <Work type=“book” id=“DA18173” />
        <Work type=“book” id=“DA18230” />
        <Work type=“book” id=“DA19291” />
    </Work>
</Literary Works>
```

As in the first example, the above sample source-independent intermediate data can then be interpreted with respect to stored database elements to populate this database with new and/or updated data in accordance with a refined source-independent database data structure.

```
<?xml version=“1.0” encoding=“utf-8” ?>
− <StandardizedLiteraryWorks>
    − <Container>
        <ContainerID>1</ContainerID>
        <ContainerType>series</ContainerType>
    </Container>
    − <ContainerWorks>
        <ContainerID>1</ContainerID>
        <WorkID>2</WorkID>
        <OrderNumber>1</OrderNumber>
    </ContainerWorks>
    − <ContainerWorks>
        <ContainerID>1</ContainerID>
        <WorkID>3</WorkID>
        <OrderNumber>2</OrderNumber>
    </ContainerWorks>
    − <ContainerWorks>
        <ContainerID>1</ContainerID>
        <WorkID>4</WorkID>
        <OrderNumber>3</OrderNumber>
    </ContainerWorks>
    − <ContainerWorks>
        <ContainerID>1</ContainerID>
        <WorkID>5</WorkID>
        <OrderNumber>4</OrderNumber>
        </ContainerWorks>
    − <Work>
        <WorkID>1</WorkID>
        <WorkType>book</WorkType>
        <Title>Hitchhiker's Guide to the Galaxy</Title>
        <PublicationDate>2005-04-01</PublicationDate>
        <Country>UK</Country>
        <Binding>hardcover</Binding>
        <NumberOfPages>224</NumberOfPages>
        <Volume>0</Volume>
        <Edition>0</Edition>
    </Work>
    − <Work>
        <WorkID>2</WorkID>
        <WorkType>book</WorkType>
        <Title>Hitchhiker's Guide to the Galaxy</Title>
        <PublicationDate>1979-10-12</PublicationDate>
        <Country>UK</Country>
        <Binding>paperback</Binding>
        <NumberOfPages>180</NumberOfPages>
        <Volume>0</Volume>
        <Edition>0</Edition>
    </Work>
    − <Work>
        <WorkID>3</WorkID>
        <WorkType>book</WorkType>
        <Title>The Restaurant at the End of the Universe</Title>
        <PublicationDate>1980-01-01</PublicationDate>
        <Country>UK</Country>
        <Binding>paperback</Binding>
        <NumberOfPages>208</NumberOfPages>
        <Volume>0</Volume>
        <Edition>0</Edition>
    </Work>
    − <Work>
        <WorkID>4</WorkID>
        <WorkType>book</WorkType>
        <Title>Life, the Universe and Everything</Title>
        <PublicationDate>1982-01-01</PublicationDate>
        <Country>UK</Country>
        <Binding>paperback</Binding>
        <NumberOfPages>160</NumberOfPages>
        <Volume>0</Volume>
        <Edition>0</Edition>
    </Work>
    − <Work>
        <WorkID>5</WorkID>
        <WorkType>book</WorkType>
        <Title>So Long, and Thanks for All the Fish</Title>
        <PublicationDate>1984-01-01</PublicationDate>
        <Country>UK</Country>
        <Binding>paperback</Binding>
        <NumberOfPages>192</NumberOfPages>
        <Volume>0</Volume>
        <Edition>0</Edition>
    </Work>
    − <Work>
        <WorkID>6</WorkID>
        <WorkType>journal</WorkType>
        <Title>TechNet</Title>
        <PublicationDate>2009-07-01</PublicationDate>
        <Country>US</Country>
        <Binding>paperback</Binding>
        <NumberOfPages>64</NumberOfPages>
        <Volume>5</Volume>
        <Edition>7</Edition>
    </Work>
    − <Work>
        <WorkID>7</WorkID>
        <WorkType>article</WorkType>
        <Title>Inside Windows 7 User Account Control</Title>
        <PublicationDate>2009-07-01</PublicationDate>
        <Country>US</Country>
        <Binding>paperback</Binding>
        <NumberOfPages>7</NumberOfPages>
        <Volume>0</Volume>
        <Edition>0</Edition>
    </Work>
    − <IdentityNumber>
        <WorkID>1</WorkID>
        <IdentityType>ISBN-10</IdentityType>
        <IdentityCode>0330437984</IdentityCode>
    </IdentityNumber>
    − <IdentityNumber>
        <WorkID>1</WorkID>
        <IdentityType>ISBN-13</IdentityType>
        <IdentityCode>9780330437981</IdentityCode>
    </IdentityNumber>
    − <IdentityNumber>
        <WorkID>2</WorkID>
        <IdentityType>ISBN-10</IdentityType>
        <IdentityCode>0330258648</IdentityCode>
    </IdentityNumber>
    − <IdentityNumber>
        <WorkID>3</WorkID>
        <IdentityType>ISBN-10</IdentityType>
        <IdentityCode>0345391810</IdentityCode>
    </IdentityNumber>
    − <IdentityNumber>
        <WorkID>4</WorkID>
        <IdentityType>ISBN-10</IdentityType>
        <IdentityCode>0330267388</IdentityCode>
    </IdentityNumber>
    − <IdentityNumber>
        <WorkID>5</WorkID>
        <IdentityType>ISBN-10</IdentityType>
        <IdentityCode>0330287001</IdentityCode>
    </IdentityNumber>
    − <IdentityNumber>
        <WorkID>6</WorkID>
        <IdentityType>ISSN</IdentityType>
        <IdentityCode>15512770</IdentityCode>
    </IdentityNumber>
    − <Entity>
        <EntityID>1</EntityID>
        <EntityType>person</EntityType>
        <FullName>Adams, Mr. Douglas</FullName>
    </Entity>
    − <Entity>
        <EntityID>2</EntityID>
        <EntityType>company</EntityType>
        <FullName>Pan Books</FullName>
    </Entity>
    − <Entity>
        <EntityID>3</EntityID>
        <EntityType>company</EntityType>
        <FullName>Pan Macmillan</FullName>
    </Entity>
    − <Entity>
        <EntityID>4</EntityID>
        <EntityType>company</EntityType>
        <FullName>Microsoft Corporation</FullName>
    </Entity>
    − <Entity>
        <EntityID>5</EntityID>
        <EntityType>company</EntityType>
        <FullName>United Business Media LLC</FullName>
    </Entity>
    − <Entity>
        <EntityID>6</EntityID>
        <EntityType>person</EntityType>
        <FullName>Hoffman, Mr. Joshua</FullName>
    </Entity>
    − <Entity>
        <EntityID>7</EntityID>
        <EntityType>person</EntityType>
        <FullName>Graven, Mr. Matthew</FullName>
    </Entity>
    − <Entity>
        <EntityID>8</EntityID>
        <EntityType>person</EntityType>
        <FullName>Terdeman, Ms. Sharon</FullName>
    </Entity>
    − <Entity>
        <EntityID>9</EntityID>
        <EntityType>person</EntityType>
        <FullName>Russinovich, Mr. Mark</FullName>
    </Entity>
    − <WorkEntity>
        <WorkID>1</WorkID>
        <EntityID>1</EntityID>
        <Relation>author</Relation>
    </WorkEntity>
    − <WorkEntity>
        <WorkID>1</WorkID>
        <EntityID>2</EntityID>
        <Relation>publisher</Relation>
    </WorkEntity>
    − <WorkEntity>
        <WorkID>2</WorkID>
        <EntityID>1</EntityID>
        <Relation>author</Relation>
    </WorkEntity>
    − <WorkEntity>
        <WorkID>2</WorkID>
        <EntityID>2</EntityID>
        <Relation>publisher</Relation>
    </WorkEntity>
    − <WorkEntity>
        <WorkID>3</WorkID>
        <EntityID>1</EntityID>
        <Relation>author</Relation>
    </WorkEntity>
    − <WorkEntity>
        <WorkID>3</WorkID>
        <EntityID>3</EntityID>
        <Relation>publisher</Relation>
    </WorkEntity>
    − <WorkEntity>
        <WorkID>4</WorkID>
        <EntityID>1</EntityID>
        <Relation>author</Relation>
    </WorkEntity>
    − <WorkEntity>
        <WorkID>4</WorkID>
        <EntityID>2</EntityID>
        <Relation>publisher</Relation>
    </WorkEntity>
    − <WorkEntity>
        <WorkID>5</WorkID>
        <EntityID>1</EntityID>
        <Relation>author</Relation>
    </WorkEntity>
    − <WorkEntity>
        <WorkID>5</WorkID>
        <EntityID>2</EntityID>
        <Relation>publisher</Relation>
    </WorkEntity>
    − <WorkEntity>
        <WorkID>6</WorkID>
        <EntityID>4</EntityID>
        <Relation>author</Relation>
    </WorkEntity>
    − <WorkEntity>
        <WorkID>6</WorkID>
        <EntityID>5</EntityID>
        <Relation>publisher</Relation>
    </WorkEntity>
    − <WorkEntity>
        <WorkID>6</WorkID>
        <EntityID>6</EntityID>
        <Relation>editor</Relation>
    </WorkEntity>
    − <WorkEntity>
        <WorkID>6</WorkID>
        <EntityID>7</EntityID>
        <Relation>editor</Relation>
    </WorkEntity>
    − <WorkEntity>
        <WorkID>6</WorkID>
        <EntityID>8</EntityID>
        <Relation>editor</Relation>
    </WorkEntity>
    − <WorkEntity>
        <WorkID>7</WorkID>
        <EntityID>9</EntityID>
        <Relation>author</Relation>
    </WorkEntity>
    − <WorkEntity>
        <WorkID>7</WorkID>
        <EntityID>5</EntityID>
        <Relation>publisher</Relation>
    </WorkEntity>
    − <WorkRelation>
        <ParentWorkID>2</ParentWorkID>
        <ChildWorkID>1</ChildWorkID>
        <Relation>republication</Relation>
    </WorkRelation>
    − <WorkRelation>
        <ParentWorkID>6</ParentWorkID>
        <ChildWorkID>7</ChildWorkID>
        <Relation>container</Relation>
    </WorkRelation>
</StandardizedLiteraryWorks>
```

It will be appreciated by the person skilled in the art that the above and other such database population methods and systems may be considered herein without departing from the general scope and nature of the present disclosure.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

The invention claimed is:

1. A method of populating a relational database of bibliographic data associated with one or more document-based collections, wherein said bibliographic data is sourced from two or more sources having distinct source-specific formats, comprising the steps of:
accessing source data from the two or more sources;
independently standardizing said accessed data from each of the two or more sources in accordance with a common intermediate source-independent format dictated by an intermediate data structure, such that similar data elements from distinct source-specific formats are commonly identified within said intermediate format; and
further interpreting said standardized data in relation to stored database elements comprising at least some database elements derived from each of the two or more sources, for populating the database in accordance with said relation with at least some repetitive elements replaced with reference thereto, consistent with a refined database data structure distinct from said intermediate data structure.

2. The method of claim 1, wherein said database data structure is normalized to a higher normal form than said intermediate structure.

3. The method of claim 1, wherein said intermediate data structure is normalized to a first normal form whereas said database data structure is normalized to a third normal form.

4. The method of claim 1, wherein said further interpreting step interrelates bibliographic data initially sourced in distinct source-specific formats and associated with documents from distinct document-based collections, via one or more data elements common to each of said documents and commonly identified within said intermediate format via said standardizing step.

5. The method of claim 1, wherein said further interpreting step comprises interpreting similar data elements associated with distinct documents as identical based on a degree of similarity between other data elements associated with said distinct documents.

6. The method of claim 1, wherein said further interpreting step is implemented via a common interpreter for all independently standardized data.

7. The method of claim 1, wherein said at least some repetitive elements existing, at least one of, within said standardized data from a single source, within said standardized data from plural sources, between said standardized data and said stored database elements, and both within said standardized data and between said standardized data and said stored database elements.

8. The method of claim 1, wherein independently standardized data from distinct sources is further interpreted at least one of simultaneously, sequentially and as available.

9. The method of claim 1, wherein said accessed data is selected from the group consisting of a single file, multiple files and a batch file.

10. The method of claim 1, wherein the database is normalized to one of first, second, third and fourth normal forms.

11. The method of claim 1, wherein said accessed data comprises metadata.

12. The method of claim 1, wherein the one or more document-based collections comprise one or more patent document-based collections.

13. The method of claim 12, wherein said stored database elements comprise metadata and patent documents.

14. The method of claim 1, wherein said database is normalized with at least one many-to-many relationship.

15. The method of claim 14, wherein said at least one many-to-many relationship is implemented using a linking table with one-to-many relationships.

16. The method of claim 1, wherein said further interpreting populates the database in accordance with said relation such that links exist in the database that are not available from any one of said two or more sources individually.

17. The method of claim 1, wherein said standardizing and further interpreting steps are implemented automatically by one or more computing devices, which one or more computing devices comprising one or more processors operatively coupled to one or more data storage devices having statements and instructions stored therein for, when executed by said one or more processors, automatically implementing said standardizing and further interpreting steps.

18. The method of claim 1, wherein said accessing step comprises one or more of acquiring said source data from at least one of said sources and accessing previously acquired source data.

19. The method of claim 1, wherein different data sets from a same document-based collection are accessed in distinct source-specific formats.

20. A system for populating a relational database of bibliographic data associated with one or more document-based collections, wherein said bibliographic data is sourced from two or more sources having distinct source-specific formats, the system comprising:
one or more data storage devices configured to define an intermediate data structure and a refined database data structure distinct therefrom, and for storing database elements derived from each of the two or more sources in accordance with said refined database data structure;
independent standardization modules for independently standardizing data accessed from the two or more sources in accordance with a common intermediate source-independent format dictated by said intermediate data structure, such that similar data elements from distinct source-specific formats are commonly identified within said intermediate format; and
an interpreter for further interpreting said standardized data in relation to said stored database elements from each of the two or more sources for populating the database in accordance with said relation with at least some repetitive elements replaced with reference thereto, consistent with said refined database data structure.

21. The system of claim 20, further comprising a decision parser for determining an appropriate standardization module for said accessed data based on an associated source-specific format thereof.

22. The system of claim 20, comprising a patent-document database system.

23. A computer-readable medium for populating a relational database of bibliographic data associated with one or more document-based collections accessed from two or more sources in distinct source-specific formats, comprising statements and instructions for implementation by a computing device to implement the steps of:
independently standardizing said accessed data from each of the two or more sources in accordance with a common intermediate source-independent format dictated by an intermediate data structure, such that similar data elements from distinct source-specific formats are commonly identified within said intermediate format; and
further interpreting said standardized data in relation to stored database elements comprising at least some database elements derived from each of the two or more sources, for populating the database in accordance with said relation with at least some repetitive elements replaced with reference thereto, consistent with a refined database data structure distinct from said intermediate data structure.

24. The computer-readable medium of claim 23, further comprising statements and instructions for parsing accessed data based on a source-specific format thereof in selecting appropriate standardizing instructions therefor.

25. The computer-readable medium of claim 23, wherein said one or more document-based collections comprise patent document-based collections.
